(19) United States
(12) Patent Application Publication
(10) Pub. No.: US 2024/0253765 A1
(43) Pub. Date: Aug. 1, 2024

(54) FOLDING WINGS FOR AN AIRCRAFT

(71) Applicant: Rohr, Inc., Chula Vista, CA (US)

(72) Inventors: Jason Habchi, San Diego, CA (US); Catlin Le, Orange, CA (US); Paul Barraza, Whittier, CA (US); Steven Kestler, San Diego, CA (US); Imad D. Ghandour, San Diego, CA (US)

(21) Appl. No.: 18/104,220

(22) Filed: Jan. 31, 2023

(51) Int. Cl. B64C 3/56

(52) U.S. Cl. CPC B64C 3/56; B64C 3/546

(57) ABSTRACT

A system is provided for an aircraft. This aircraft system includes an aircraft wing extending spanwise from a wing base to a wing tip. The aircraft wing extends chordwise from a leading edge to a trailing edge. The aircraft wing extends laterally between a first surface and a second surface. The aircraft wing includes a first section, a second section and a third section. The second section extends spanwise between and connects the third section and the first section. The second section is pivotally connected to first section at a first hinge line. The third section is pivotally connected to the second section at a second hinge line that is angularly offset from the first hinge line by a first acute angle.

### BACKGROUND

### 1. Technical Field

This disclosure relates generally to an aircraft and, more particularly, to wings of the aircraft.

### 2. Background Information

An aircraft may include foldable wings. Various types and configurations of foldable wings are known in the art. While these known foldable wings have various benefits, there is still room in the art for improvement. There is a need in the art therefore for improved foldable wings, particularly foldable wings that can meet both on ground and inflight requirements.

### SUMMARY OF THE DISCLOSURE

According to an aspect of the present disclosure, a system is provided for an aircraft. This aircraft system includes an aircraft wing extending spanwise from a wing base to a wing tip. The aircraft wing extends chordwise from a leading edge to a trailing edge. The aircraft wing extends laterally between a first surface and a second surface. The aircraft wing includes a first section, a second section and a third section. The second section extends spanwise between and connects the third section and the first section. The second section is pivotally connected to first section at a first hinge line. The third section is pivotally connected to the second section at a second hinge line that is angularly offset from the first hinge line by a first acute angle.

According to another aspect of the present disclosure, another system is provided for an aircraft. This aircraft system includes an aircraft fuselage, an aircraft wing and an actuation system. The aircraft wing is connected to and projects spanwise out from the aircraft fuselage to a wing tip. The aircraft wing extends chordwise from a leading edge to a trailing edge. The aircraft wing extends laterally between a first surface and a second surface. The aircraft wing includes a first section, a second section and a third section. The second section is spanwise between the third section and the first section. The second section is pivotally connected to first section at a first hinge line. The third section is pivotally connected to the second section at a second hinge line. The actuation system is configured to: actively pivot the second section about the first hinge line during a first mode while the third section is fixed to the second section and the aircraft is on ground; and passively pivot of the third section about the second hinge line during a second mode while the second section is fixed to the first section and the aircraft is in flight.

According to still another aspect of the present disclosure, a method is provided for operating an aircraft. The aircraft includes an aircraft wing projecting spanwise to a wing tip. The aircraft wing includes a first section, a second section and a third section. The second section is spanwise between the third section and the first section. The second section is pivotable about a first hinge line. The third section is pivotable about a second hinge line. The method includes: pivoting the second section about the first hinge line and relative to the first section during a first mode while the third section is fixed relative to the second section and the aircraft is on ground; and pivoting the third section about the second hinge line and relative to the second section during a second mode while the second section is fixed to the first section and the aircraft is in flight.

The first acute angle may be less than fifteen degrees.

The first acute angle may be between fifteen degrees and thirty degrees.

The first acute angle may be greater than thirty degrees.

The system may also include an aircraft fuselage extending longitudinally along a centerline. The first hinge line may be arranged parallel with the centerline.

The system may also include an aircraft fuselage extending longitudinally along a centerline. The second hinge line may be angularly offset from the centerline by a second acute angle.

The second acute angle may be equal to the first acute angle.

The system may also include an actuation system configured to pivot the second section about the first hinge line between a first position and a second position. The second section may be arranged inline with the first section when the second section is in the first position. The second section may be angularly offset from the first section by a pivot angle when the second section is in the second position.

The pivot angle may be between thirty degrees and seventy degrees.

The pivot angle may be between seventy degrees and one-hundred and ten degrees.

The actuation system may be configured to lock the second section in at least one of the first position or the second position.

The third section may be arranged inline with and fixed to second section when the second section pivots between the first position and the second position.

The system may also include an actuation system configured to facilitate pivoting of the third section about the second hinge line between a first position and a second position. The third section may be arranged inline with the second section when the third section is in the first position. The third section may be angularly offset from the second section by a pivot angle when the third section is in the second position.

The pivot angle may be greater than zero degrees and less than five degrees.

The pivot angle may be between five degrees and twenty degrees.

The pivot angle may be between twenty degrees and forty-five degrees.

The pivot angle may be greater than forty-five degrees.

The actuation system may be configured to: lock the third section in the first position; and pivot the third section between the first position and the second position.

The second section may be arranged inline with and fixed to first section when the third section pivots between the first position and the second position.

The actuation system may be configured to damp pivoting of the third section about the second hinge line.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a front end illustration of an aircraft.

FIG. 2 is a top side illustration of the aircraft.

FIG. 3 is a front end illustration of a side of the aircraft with a wing in a fully extended configuration.

FIG. 4 is a front end illustration of the side of the aircraft with its wing in a collapsed configuration.

FIG. 5 is a front end illustration of the side of the aircraft with a wing in a semi-extended configuration.

FIG. 6 is a plan view illustration of a portion of the wing.

FIG. 7 is a schematic illustration of intermediate and tip wing sections arranged with a wing actuation system.

FIG. 8 is a flow diagram of a method for operating an aircraft.

### DETAILED DESCRIPTION

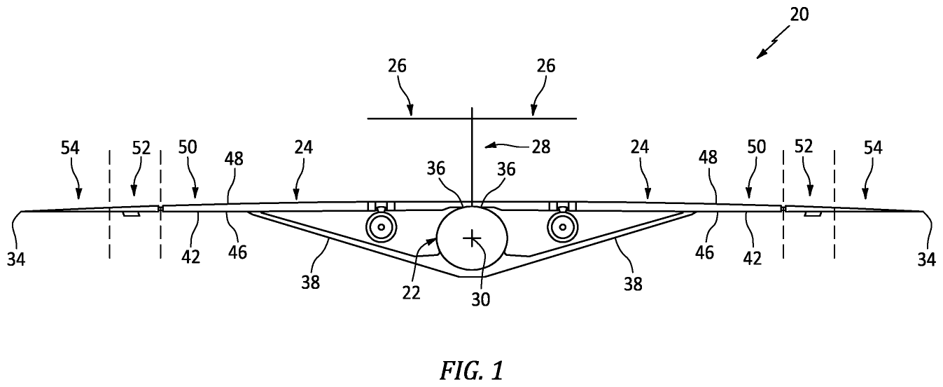

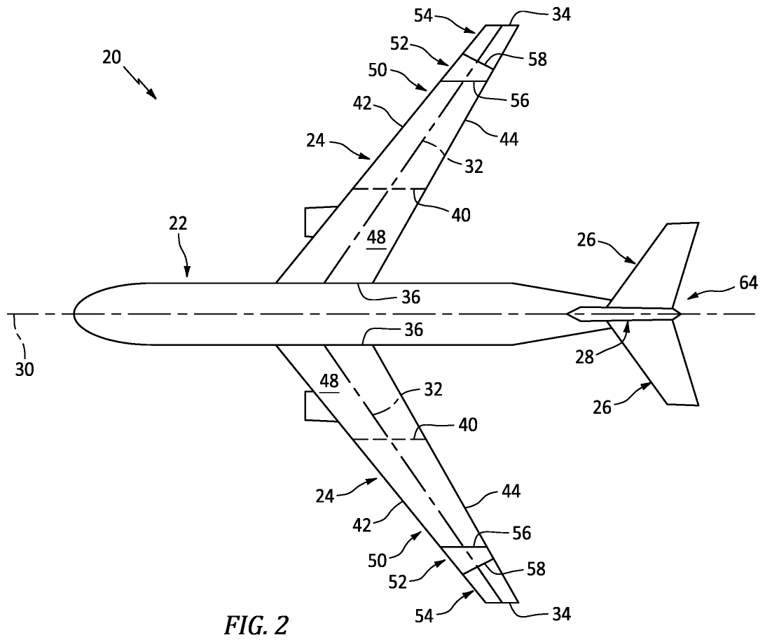

FIG. 1 is a front end illustration of an aircraft 20. FIG. 2 is a top side illustration of the aircraft 20. The aircraft 20 of FIGS. 1 and 2 is configured as a truss-braced, high aspect ratio wing airplane. The present disclosure, however, is not limited to such an exemplary aircraft. The aircraft 20, for example, may be configured as any type of low wing, mid wing or high wing aerial vehicle; e.g., airplane, drone, etc. The aircraft 20 of FIGS. 1 and 2 includes an aircraft fuselage 22 and one or more aircraft wings 24. The aircraft 20 may also include one or more stabilizers such as one or more horizontal stabilizers 26 and a vertical stabilizer 28.

The aircraft fuselage 22 extends longitudinally along a longitudinal centerline 30. This longitudinal centerline 30 may be a centerline of the aircraft 20 and/or the aircraft fuselage 22.

Referring to FIG. 2, the aircraft wings 24 are disposed on opposing sides of the aircraft fuselage 22. Each aircraft wing 24 projects spanwise along a span line 32 of the respective aircraft wing 24 out from the aircraft fuselage 22 to a tip 34 of the respective aircraft wing 24. More particularly, each aircraft wing 24 extends spanwise along its span line 32 from a base 36 of the respective aircraft wing 24 to its wing tip 34. Each aircraft wing 24 is connected to the aircraft fuselage 22 at (e.g., on, adjacent or proximate) its wing base 36. Each aircraft wing 24 of FIG. 1 is also connected to the aircraft fuselage 22 and supported by a truss brace 38. In other embodiments, however, all supports and bracing for the aircraft wings 24 may be internal to the aircraft wings 24.

Each aircraft wing 24 of FIG. 2 extends chordwise along a chord line 40 of the respective aircraft wing 24 between and to a leading edge 42 of the respective aircraft wing 24 and a trailing edge 44 of the respective aircraft wing 24. The leading edge 42 extends spanwise from the wing base 36 to the wing tip 34. The trailing edge 44 extends spanwise from the wing base 36 to the wing tip 34.

Each aircraft wing 24 of FIG. 1 extends laterally along a thickness of the respective aircraft wing 24 between and to a bottom, lower surface 46 of the respective aircraft wing 24 and a top, upper surface 48 of the respective aircraft wing 24. The wing lower surface 46 is disposed below the wing upper surface 48 (with respect to gravity) when, for example, the aircraft 20 is on ground and/or during normal horizontal flight. Referring to FIG. 2, each wing surface 46, 48 may extend spanwise from the wing base 36 to the wing tip 34. Each wing surface 46, 48 may extend chordwise from the wing leading edge 42 to the wing trailing edge 44. When each aircraft wing 24 is fully extended as shown in FIGS. 1 and 2, each wing surface 46, 48 may be substantially continuous without, for example, any interior corners, exterior corners and/or sharp (e.g., small radius) bends particularly when viewed in a first reference plane perpendicular to the longitudinal centerline 30; e.g., plane of FIG. 1.

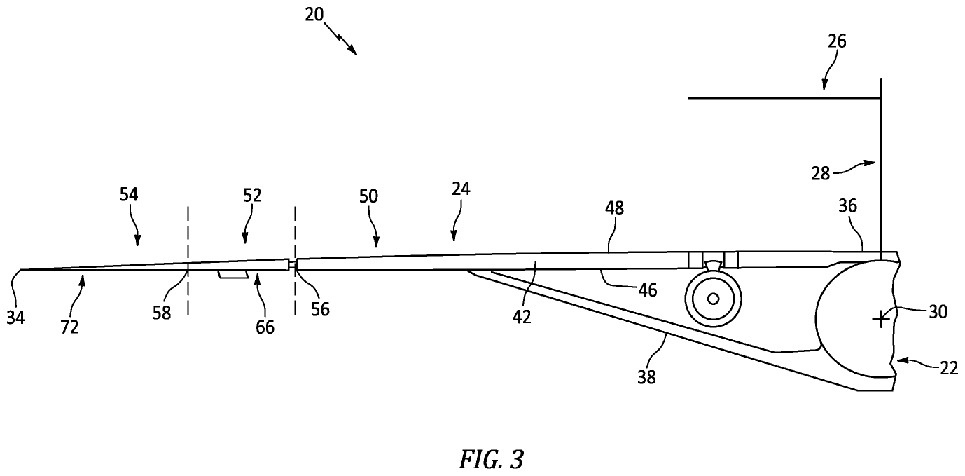

Referring to FIG. 3, each aircraft wing 24 includes a plurality of wing sections such as, but not limited to, a base section 50, an inner intermediate section 52 and an outer tip section 54. Each of these wing sections 50, 52, 54 forms a segment of the respective aircraft wing 24 along the span line 32 (see FIG. 2). The base section 50 of FIG. 3, for example, forms a segment of the respective aircraft wing 24 projecting spanwise out from the aircraft fuselage 22 to the intermediate section 52. This base section 50 may account for between thirty percent (30%) and sixty percent (60%) or between sixty percent (60%) and ninety percent (90%) of a span length of the respective aircraft wing 24. The intermediate section 52 of FIG. 3 forms a segment of the respective aircraft wing 24 extending spanwise between a spanwise outer end of the base section 50 and a spanwise inner end of the tip section 54. This intermediate section 52 may account for between five percent (5%) and ten percent (10%) or between ten percent (10%) and forty percent (40%) of the wing span length. The tip section 54 of FIG. 3 forms a segment of the respective aircraft wing 24 projecting spanwise out from the intermediate section 52 to the wing tip 34. This tip section 54 may account for between five percent (5%) and fifteen percent (15%) or between fifteen percent (15%) and thirty percent (30%) of the wing span length. The present disclosure, however, is not limited to the foregoing exemplary dimensional relationships.

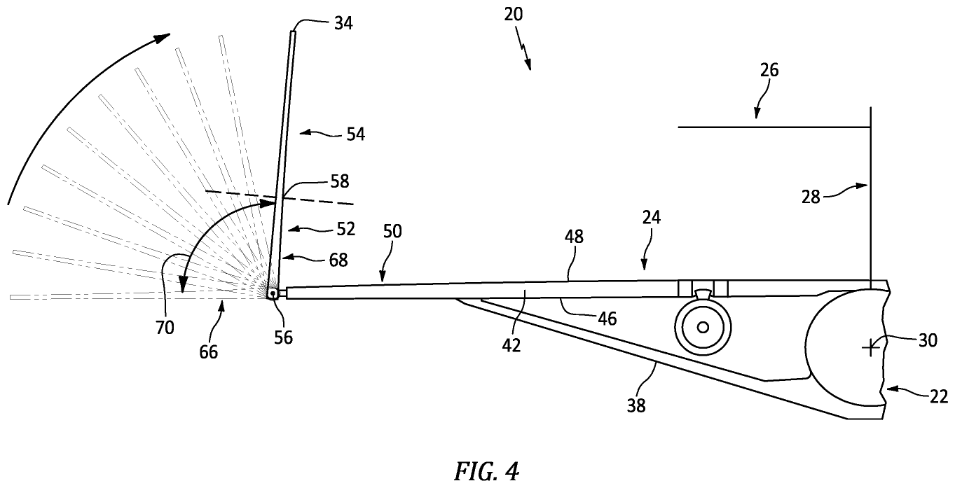

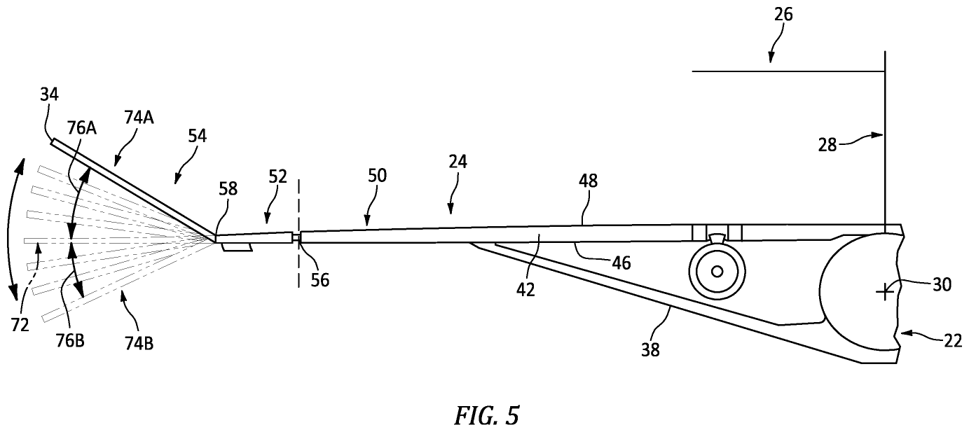

Each of the wing sections 50, 52, 54 may be configured as a unitary, rigid structure. By contrast, the wing sections 50, 52 and 54 provide the respective aircraft wing 24 with a multi-section, foldable or otherwise deformable structure. The base section 50 of FIGS. 3-5, for example, is fixedly attached to the aircraft fuselage 22. Thus, the base section 50 remains stationary relative to the aircraft fuselage 22 during aircraft operation. By contrast, referring to FIGS. 3 and 4, the intermediate section 52 is movably connected to the base section 50. The intermediate section 52 of FIGS. 3 and 4, for example, is pivotally connected to the base section 50 via an inner hinge and/or another pivotable joint at an inner hinge line 56; e.g., an inner pivot axis. Similarly, referring to FIGS. 3 and 5, the tip section 54 is movably connected to the intermediate section 52. The tip section 54 of FIGS. 3 and 5, for example, is pivotally connected to the intermediate section 52 via an outer hinge and/or another pivotable joint at an outer hinge line 58; e.g., an outer pivot axis.

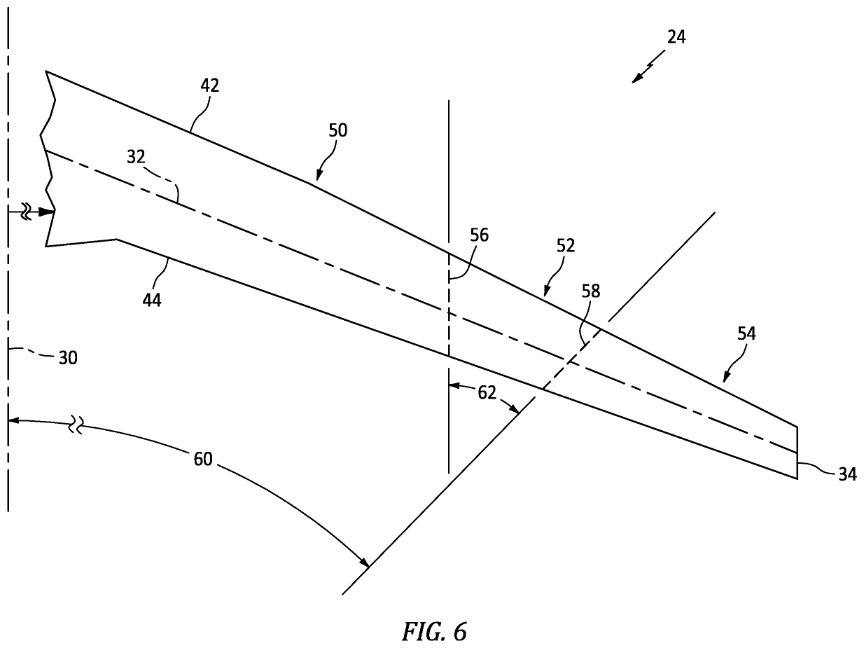

Referring to FIG. 6, the inner hinge line 56 may be arranged parallel with the longitudinal centerline 30 when viewed, for example, in a second reference plane parallel with (e.g., including) the longitudinal centerline 30; e.g., plane of FIG. 6. It is contemplated, however, in other embodiments the inner hinge line 56 may alternatively be angularly offset from the longitudinal centerline 30 by an inner hinge line angle; e.g., a non-zero acute angle up to five, ten or fifteen degrees (5°, 10° or 15°). Referring again to FIG. 6, the outer hinge line 58 is angularly offset from the longitudinal centerline 30 by a first outer hinge line angle 60. This first outer hinge line angle 60 may be a non-zero acute angle, for example, less than fifteen degrees (15°), between fifteen degrees (15°) and thirty degrees (30°), or greater than thirty degrees (30°). The outer hinge line 58 is also angularly offset from the inner hinge line 56 by a second outer hinge line angle 62. This second outer hinge line angle 62 may be equal to or different (e.g., slightly greater or less) than the first outer hinge line angle 60. The second outer hinge line angle 62 may be a non-zero acute angle, for example, less than fifteen degrees (15°), between fifteen degrees (15°) and thirty degrees (30°), or greater than thirty degrees (30°). The outer hinge line 58 of FIG. 6 is oriented such than a portion of the outer hinge line 58 at the wing leading edge 42 is positioned further away from the aircraft fuselage 22 (see FIG. 2) and the longitudinal centerline 30 than a portion of the outer hinge line 58 at the wing trailing edge 44; e.g., as measured in a direction perpendicular to the longitudinal centerline 30. The outer hinge line 58 may thereby be canted (e.g., angled) inwards towards a tail end 64 of the aircraft 20 (see FIG. 2).

Referring to FIGS. 3 and 4, the intermediate section 52 is movable (e.g., pivotable) between a first position 66 and a second position 68. At the intermediate section first position 66 of FIG. 3, the intermediate section 52 may be arranged inline with the base section 50. The intermediate section 52, for example, may be parallel with the base section 50 when viewed, for example, in the first reference plane. The intermediate section 52 may thereby be configured as a spanwise extension of the base section 50. By contrast, at the intermediate section second position 68 of FIG. 4, the intermediate section 52 may be angularly offset from the base section 50 by an inner hinge line pivot angle 70; e.g., measured along a path of movement. This inner hinge line pivot angle 70 may be a non-zero acute angle, a right angle or an obtuse angle. The inner hinge line pivot angle 70, for example, may be between thirty degrees (30°) and seventy degrees (70°), between seventy degrees (70°) and one-hundred and ten degrees (110°), or more than one-hundred and ten degrees (110°). The aircraft wing 24 may thereby be bent at an intersection between the base section 50 and the intermediate section 52. The present disclosure, however, is not limited to the foregoing exemplary angular relationships.

Referring to FIGS. 3 and 5, the tip section 54 is movable (e.g., pivotable) between a first position 72 and a second position 74A and/or 74B (generally referred to as “74”). At the tip section first position 72 of FIG. 3, the tip section 54 may be arranged inline with the intermediate section 52 (and the base section 50). The tip section 54, for example, may be parallel with the intermediate section 52 (and the base section 50) when viewed, for example, in the first reference plane. The tip section 54 may thereby be configured as a spanwise extension of the intermediate section 52 (and the base section 50). By contrast, at the tip section second position 74 of FIG. 5, the tip section 54 may be angularly offset from the intermediate section 52 (and the base section 50) by an outer hinge line pivot angle 76A, 76B (generally referred to as “76”); e.g., measured along a path of movement. This outer hinge line pivot angle 76 may be a non-zero acute angle. The outer hinge line pivot angle 76, for example, may be between five degrees (5°) and twenty degrees (20°), between twenty degrees (20°) and forty-five degrees) (45°, or more than forty-five degrees (45°). Note, while the foregoing exemplary angles are described as positive angles, it is also contemplated these same angles may alternatively be negative angles. The aircraft wing 24 may thereby be bent at an intersection between the intermediate section 52 and the tip section 54. The present disclosure, however, is not limited to the foregoing exemplary angular relationships.

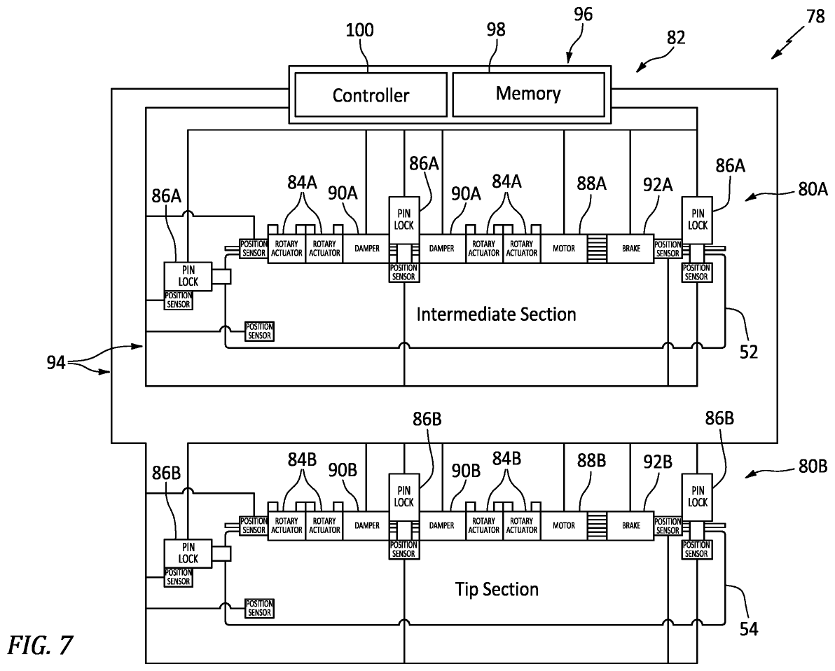

Referring to FIG. 7, to control movement of the various wing sections 52 and 54, each aircraft wing 24 is provided with a wing actuation system 78. This wing actuation system 78 includes an intermediate section actuation system 80A and a tip section actuation system 80B. The wing actuation system 78 also includes a control system 82 to control and/or coordinate operation of the intermediate section actuation system 80A and the tip section actuation system 80B.

Each wing section actuation system 80A, 80B (generally referred to as “80”) of FIG. 7 includes one or more rotary actuators 84A, 84B (generally referred to as “84”) and one or more lock devices 86A, 86B (generally referred to as “86”). The rotary actuators 84 are configured to pivot the respective wing section 50, 52 about its hinge line 56, 58. One or more or all of the rotary actuators 84A, 84B, for example, may be coupled to a motor 88A, 88B (generally referred to as “88”), where the motor 88 drives operation of the rotary actuators 84 and, thus, pivoting of the respective wing section 52, 54. Examples of the motor 88 include, but are not limited to, an electric motor and a hydraulic motor. The lock devices 86, by contrast, are configured to fix a position of the respective wing section 52, 54 about its hinge line 56, 58. The lock devices 86A of the intermediate section actuation system 80A, for example, may lock (e.g., rotationally fix) the intermediate section 52 in its first position 66 of FIG. 3 and/or its second position 68 of FIG. 4. The lock devices 86A of the intermediate section actuation system 80A, however, may be unlocked to facilitate pivoting the intermediate section 52 by the rotary actuators 84 between the first position 66 of FIG. 3 and the second position 68 of FIG. 4. In another example, the lock devices 86B of the tip section actuation system 80B may lock (e.g., rotationally fix) the tip section 54 in its first position 72 of FIG. 3. The lock devices 86B of the tip section actuation system 80B, however, may be unlocked to facilitate pivoting of the tip section 54 about its outer hinge line 58 when not in the first position 72 of FIG. 3, or when not intended to remain fixed in the first position 72 of FIG. 3. The pivoting of the tip section 54 about its outer hinge line 58 may be active movement driven by the rotary actuators 84B. Alternatively, the pivoting of the tip section 54 about its outer hinge line 58 may be passive (e.g., free) movement driven by movement of the tip section 54 through air during aircraft flight.

Each wing section actuation system 80A, 80B may also include one or more dampers 90A, 90B (generally referred to as “90”) and/or at least one brake 92A, 92B (generally referred to as “92”). The dampers 90 are configured to damp pivoting of the respective wing section 52, 54 about its hinge line 56, 58. The brake 92 is configured to brake (e.g., slow or stop) pivoting of the respective wing section 52, 54 about its hinge line 56, 58. For example, the brake 92 may be used to stop and hold the respective wing section 52, 54 in position while the lock devices 86 are engaged; e.g., locked. Alternatively, it is contemplated the lock devices 86 may be omitted and the brake 92 may be used to hold the position of the respective wing section 52, 54.

The control system 82 includes a sensor system 94 and a controller 96. The sensor system 94 is configured to monitor a rotational position of each wing section 52, 54 about its respective hinge line 56, 58. The sensor system 94, for example, may include one or more position sensors arranged with each respective wing section 52, 54. The sensor system 94 may also include one or more position sensors arranged with the lock devices 86 configured to monitor operation of the lock devices 86.

The controller 96 is in signal communication (e.g., hardwired and/or wirelessly coupled) with one or more of the wing actuation system elements 80 and 94. The controller 96 may be implemented with a combination of hardware and software. The hardware may include memory 98 and at least one processing device 100, which processing device 100 may include one or more single-core and/or multi-core processors. The hardware may also or alternatively include analog and/or digital circuitry other than that described above.

The memory 98 is configured to store software (e.g., program instructions) for execution by the processing device 100, which software execution may control and/or facilitate performance of one or more operations such as those described below. The memory 98 may be a non-transitory computer readable medium. For example, the memory 98 may be configured as or include a volatile memory and/or a nonvolatile memory. Examples of a volatile memory may include a random access memory (RAM) such as a dynamic random access memory (DRAM), a static random access memory (SRAM), a synchronous dynamic random access memory (SDRAM), a video random access memory (VRAM), etc. Examples of a nonvolatile memory may include a read only memory (ROM), an electrically erasable programmable read-only memory (EEPROM), a computer hard drive, etc.

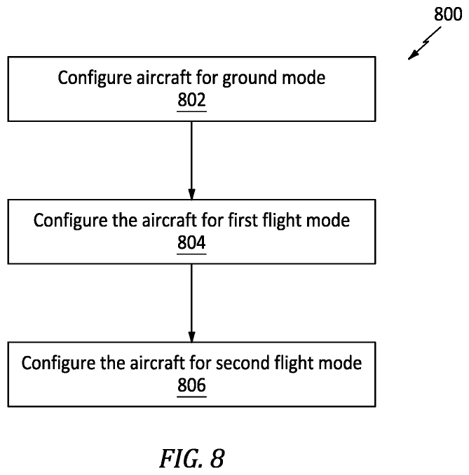

FIG. 8 is a flow diagram of a method 800 for operating an aircraft. For ease of description, the operating method 800 is described below with respect to the aircraft 20 of FIGS. 1-7. The operating method 800 of the present disclosure, however, is not limited to such an exemplary aircraft and aircraft wings.

In step 802, during a ground mode of operation, the aircraft 20 is configured for operation at an airport; e.g., on ground operation. The control system 82, for example, may signal the wing section actuation systems 80 to arrange the wing sections 52 and 54 into the collapsed/compact configuration of FIG. 4. In particular, each intermediate section 52 is pivoted to and locked in its second position 68. Each tip section 54 may be maintained inline with and rotational fixed with the respective intermediate section 52. With this arrangement, an effective wingspan of the aircraft 20 may be reduced (e.g., minimized) to facilitate easier maneuvering and/or parking of the aircraft 20 at the airport. The aircraft wings 24, for example, may be arranged with the collapsed/compact configuration of FIG. 4 for taxiing about the airport and/or parking at a terminal gate.

In step 804, during a first flight mode of operation, the aircraft 20 is configured for flight under a first set of conditions; e.g., normal flight conditions. The control system 82, for example, may signal the wing section actuation systems 80 to arrange the wing sections 52 and 54 into the deployed/fully extended configuration of FIG. 3. In particular, each intermediate section 52 is pivoted to and locked in its first position 66. Each tip section 54 may be maintained inline with and rotationally fixed with the respective intermediate section 52 in its first position 72. With this arrangement, the effective wingspan may be increased (e.g., maximized) to facilitate improved flight capability. The aircraft wings 24, for example, may be arranged with the deployed/fully extended configuration of FIG. 3 for aircraft takeoff, climb, cruise, descent and/or landing. Of course, it is contemplated each tip section 54 may alternatively be unlocked and allowed to passively pivot about the outer hinge line 58 as described below where, for example, the aircraft 20 experiences unusual conditions during the aircraft takeoff, climb, cruise, descent and/or landing.

In step 806, during a second flight mode of operation, the aircraft 20 is configured for flight under a second set of conditions; e.g., unusual flight conditions. The control system 82, for example, may signal the wing section actuation systems 80 to arrange the wing sections 52 and 54 into the semi-extended/modified configuration of FIG. 5. In particular, each intermediate section 52 may be maintained inline with and rotationally fixed with the respective base section 50 in its first position 66. Each tip section 54, on the other hand, may be unlocked and allowed to passively (e.g., freely, without use of the rotary actuators 84) pivot about the outer hinge line 58 from its first position 72 to its second position 74, from its second position 74 to its first position 72, between the second positions 74A and 74B, or anywhere in between. With this arrangement, the tip sections 54 may facilitate a more stable flight condition through high gusting winds and/or facilitate a more stable flight condition during relatively rapid aircraft maneuvers; e.g., tight turns, etc. Of course, it is contemplated the tip sections 54 may alternatively be actively moved to the second position 74 (and/or one or more intermediate positions) and/or locked in the second position 74 (and/or one or more intermediate positions) for certain flight conditions. The tip sections 54, for example, may alternatively function as fixed winglets.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A system for an aircraft, comprising:
an aircraft wing extending spanwise from a wing base to a wing tip, the aircraft wing extending chordwise from a leading edge to a trailing edge, the aircraft wing extending laterally between a first surface and a second surface, and the aircraft wing including a first section, a second section and a third section;
the second section spanwise between and connecting the third section and the first section, and the second section pivotally connected to first section at a first hinge line; and
the third section pivotally connected to the second section at a second hinge line that is angularly offset from the first hinge line by a first acute angle.

2. The system of claim 1, wherein the first acute angle is less than fifteen degrees.

3. The system of claim 1, wherein the first acute angle is between fifteen degrees and thirty degrees.

4. The system of claim 1, wherein the first acute angle is greater than thirty degrees.

5. The system of claim 1, further comprising:
an aircraft fuselage extending longitudinally along a centerline; and
the first hinge line arranged parallel with the centerline.

6. The system of claim 1, further comprising:
an aircraft fuselage extending longitudinally along a centerline; and
the second hinge line angularly offset from the centerline by a second acute angle.

7. The system of claim 6, wherein the second acute angle is equal to the first acute angle.

8. The system of claim 1, further comprising:
an actuation system configured to pivot the second section about the first hinge line between a first position and a second position;
the second section arranged inline with the first section when the second section is in the first position; and
the second section angularly offset from the first section by a pivot angle when the second section is in the second position.

9. The system of claim 8, wherein the pivot angle is between thirty degrees and seventy degrees.

10. The system of claim 8, wherein the pivot angle is between seventy degrees and one-hundred and ten degrees.

11. The system of claim 8, wherein the actuation system is configured to lock the second section in at least one of the first position or the second position.

12. The system of claim 8, wherein the third section is arranged inline with and fixed to second section when the second section pivots between the first position and the second position.

13. The system of claim 1, further comprising:
an actuation system configured to facilitate pivoting of the third section about the second hinge line between a first position and a second position;
the third section arranged inline with the second section when the third section is in the first position; and
the third section angularly offset from the second section by a pivot angle when the third section is in the second position.

14. The system of claim 13, wherein the pivot angle is between five degrees and twenty degrees.

15. The system of claim 13, wherein the pivot angle is between twenty degrees and forty-five degrees.

16. The system of claim 13, wherein the actuation system is configured to
lock the third section in the first position; and
pivot the third section between the first position and the second position.

17. The system of claim 13, wherein the second section is arranged inline with and fixed to first section when the third section pivots between the first position and the second position.

18. The system of claim 13, wherein the actuation system is configured to damp pivoting of the third section about the second hinge line.

19. An aircraft, comprising:
an aircraft fuselage;
an aircraft wing connected to and projecting spanwise out from the aircraft fuselage to a wing tip, the aircraft wing extending chordwise from a leading edge to a trailing edge, the aircraft wing extending laterally between a first surface and a second surface, the aircraft wing including a first section, a second section and a third section, the second section spanwise between the third section and the first section, the second section pivotally connected to first section at a first hinge line, and the third section pivotally connected to the second section at a second hinge line; and
an actuation system configured to
actively pivot the second section about the first hinge line during a first mode while the third section is fixed to the second section and the aircraft is on ground; and
passively pivot of the third section about the second hinge line during a second mode while the second section is fixed to the first section and the aircraft is in flight.

20. A method for operating an aircraft, comprising:
the aircraft including an aircraft wing projecting spanwise to a wing tip;
the aircraft wing including a first section, a second section and a third section, the second section spanwise between the third section and the first section, the second section pivotable about a first hinge line, and the third section pivotable about a second hinge line;
pivoting the second section about the first hinge line and relative to the first section during a first mode while the third section is fixed relative to the second section and the aircraft is on ground; and
pivoting the third section about the second hinge line and relative to the second section during a second mode while the second section is fixed to the first section and the aircraft is in flight.
